(19) United States
(12) Patent Application Publication
(10) Pub. No.: US 2005/0265136 A1
(43) Pub. Date: Dec. 1, 2005

(54) Feedback control system and method thereof

(75) Inventor: Chiou--Ming Wu, Taipei (TW)

Correspondence Address: BACON & THOMAS, PLLC, 625 SLATERS LANE, FOURTH FLOOR, ALEXANDRIA, VA, 22314, US

(73) Assignee: LITE-ON IT CORPORATION, Taipei (TW)

(21) Appl. No.: 11/123,062

(22) Filed: May 6, 2005

(30) Foreign Application Priority Data
May 27, 2004 (TW) 93115180

(51) Int. Cl. G11B 7/00

(52) U.S. Cl. 369/44.11; 369/44.29; 369/124.01

(57) ABSTRACT

A feedback control system includes an optical pickup head, a temperature sensor, a microcontroller and a servo control system. The optical pickup head emits a laser beam onto an optical disk to read/write data. The temperature sensor senses an operating temperature of the optical pickup head, and outputs a corresponding feedback signal. The microcontroller outputs a corresponding control parameter according to the feedback signal. The servo control system adjusts a system characteristic parameter of the optical pickup head according to the control parameter.

This application claims the benefit of Taiwan application Serial No. 93115180, filed May 27, 2004, the subject matter of which is incorporated herein by reference.

### BACKGROUND OF THE INVENTION

1. Field of the Invention

The invention relates in general to a feedback control system and a feedback control method, and more particularly to a feedback control system capable of executing temperature compensation and method thereof.

2. Description of the Related Art

FIG. 1 is a circuit block diagram showing a conventional feedback control system. Referring to FIG. 1, an optical read/write control system 100 includes an optical pickup head 110, a radio frequency amplifier 120, a digital signal processing (DSP) controller 130, a drive integrated circuit (IC) 140 and a microcontroller 150. The optical pickup head 110 emits a laser beam L onto an optical disk 111 so as to read/write data on the optical disk 111. The laser beam L is reflected by the optical disk 111 and then the optical pickup head 110 converts the reflected beam into an electrical signal Se for output.

The radio frequency amplifier 120 amplifies the electrical signal Se and then outputs the amplified electrical signal Se' to the DSP controller 130. The DSP controller 130, which is controlled by the microcontroller 150, transmits the data signal of the electrical signal Se' to a decoder (not shown), which decodes the electrical signal Se'. Also, the DSP controller 130 calculates the electrical signal Se' to generate some error signals, such as tracking error signal and focus error signal. The DSP controller 130 also controls the drive IC 140 to drive the optical pickup head 110 to perform focusing and tracking operations according to error signals. Thus, the optical read/write control system 100 can correctly read/write data on the optical disk 111.

However, due to the structure and material of the optical pickup head 110, the long-term operation of the optical pickup head 110 causes the system temperature to rise above the room temperature. Thus, the system characteristic parameters of the optical pickup head 110, such as the DC gain, bandwidth, phase margin and gain margin, may be changed. Consequently, the stability and efficiency of the focusing and tracking operations performed by the optical pickup head 110 are influenced, and the optical pickup head 110 may read/write data on the optical disk 111 with poor quality.

### SUMMARY OF THE INVENTION

It is therefore an object of the invention to provide a feedback control system and method thereof, in which a feedback value sensed by a temperature sensor is utilized to control a DSP controller to perform a temperature compensation for system characteristic parameters of an optical pickup head so as to enhance the stability of the optical pickup head in performing focusing and tracking operations and thus enhance the data reading/writing quality.

The invention achieves the above-identified object by providing a feedback control system used in an optical disk drive, which accesses data on an optical disk. The feedback control system includes an optical pickup head, a temperature sensor, a microcontroller and a servo control system. The optical pickup head emits a laser beam onto the optical disk to read/write data. The temperature sensor senses an operating temperature of the feedback control system and outputs a corresponding feedback signal. The microcontroller outputs a corresponding control parameter according to the feedback signal. According to the control parameter, the servo control system adjusts a system characteristic parameter of the optical pickup head.

The servo control system includes a DSP controller and a drive IC. The DSP controller adjusts pole and zero positions according to the control parameter so as to adjust the system characteristic parameter of the optical pickup head. The system characteristic parameter is adjusted to be the same as that of the optical pickup head as operating at a room temperature. Thus, the optical pickup head can perform precise focusing and tracking operations according to the temperature compensation of the system characteristic parameter.

The invention also achieves the above-identified object by providing a feedback control method used in an optical disk drive, which includes an optical pickup head and a servo control system. The servo control system outputs a servo parameter to control the optical pickup head. The feedback control method includes the steps of: sensing an operating temperature of the optical pickup head to obtain a feedback value corresponding to the operating temperature; and changing the servo parameter according to the feedback value so as to adjust a system characteristic parameter of the optical pickup head. A parameter look-up table is set by firmware, to include a plurality of feedback value ranges and control parameters corresponding to the feedback value ranges. The step of adjusting the system characteristic parameter of the optical pickup head includes obtaining the corresponding control parameter from the parameter look-up table according to the feedback value; and changing the servo parameter according to the control parameter in order to adjust the system characteristic parameter.

The servo control system includes a DSP controller, and the step of changing the servo parameter according to the control parameter includes adjusting pole and zero positions of the DSP controller according to the control parameter and thus changing the servo parameter. The feedback control method adjusts and holds the system characteristic parameter is held the same as that of the optical pickup head when operating at a room temperature. Thus, the optical pickup head can perform more precise focusing and tracking operations according to the temperature compensation of the system characteristic parameter.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 (Prior Art) is a circuit block diagram showing a conventional feedback control system.

FIG. 2 is a circuit block diagram showing an optical read/write system according to a preferred embodiment of the invention.

FIG. 3A is a flow chart showing a feedback control method according to a preferred embodiment of the invention.

FIG. 3B shows a parameter look-up table of feedback value ranges and control parameters set by firmware in the microcontroller of FIG. 3A.

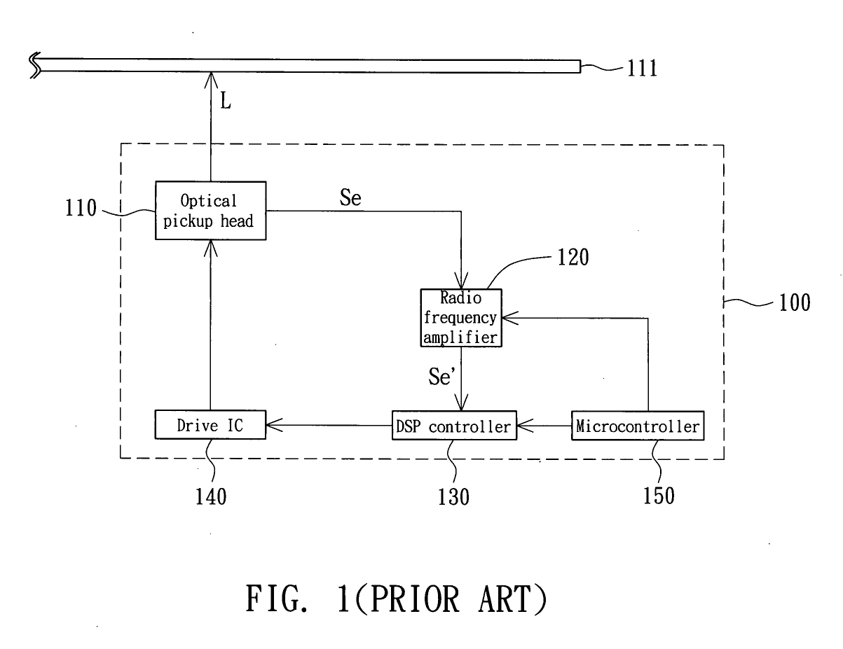

### DETAILED DESCRIPTION OF THE INVENTION

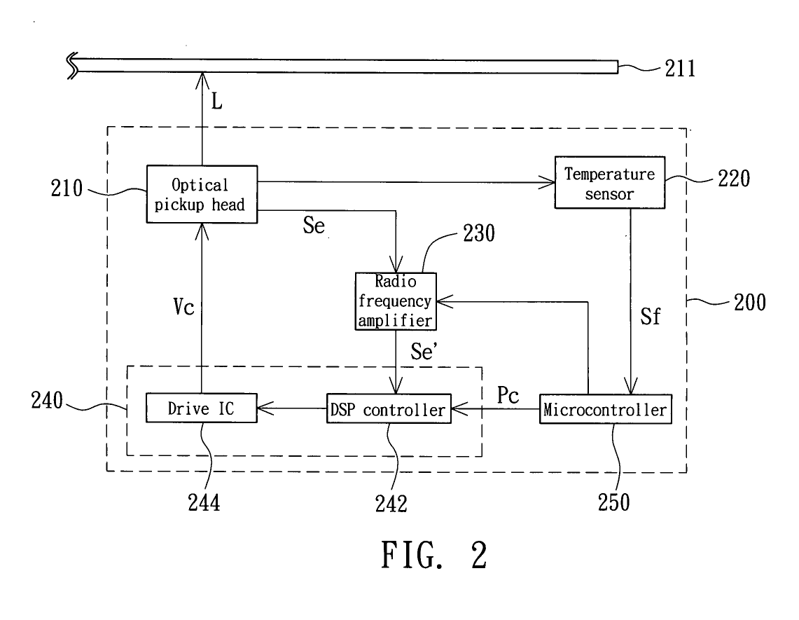

FIG. 2 is a circuit block diagram showing an optical read/write system according to a preferred embodiment of the invention. Referring to FIG. 2, a feedback control system 200 includes an optical pickup head 210, a temperature sensor 220, a radio frequency amplifier 230, a servo control system 240 and a microcontroller 250. The optical pickup head 210 emits a laser beam L onto an optical disk 211 in order to read/write data on the optical disk 211. As mentioned above, the optical pickup head 210 converts the laser beam L, which is reflected from the optical disk 211, into an electrical signal Se, which is then amplified by the radio frequency amplifier 230 and the amplified electrical signal Se' is outputted to the servo control system 240. The electrical signal Se' includes a focusing error signal and a tracking error signal. The servo control system 240, which is controlled by the microcontroller 250, outputs a control voltage Vc to control focusing and tracking operations of the optical pickup head 210 according to error signals of the electrical signal Se'.

The temperature sensor 220 senses an operating temperature of the optical pickup head 210 and outputs a feedback signal Sf corresponding to the operating temperature. The temperature sensor 220 can be, for example, a thermistor, and the feedback signal Sf can be, for example, a voltage drop between two ends of the thermistor. The microcontroller 250 outputs a corresponding control parameter Pc according to the feedback signal Sf for controlling the servo control system 240 to drive the optical pickup head 210 to perform the focusing and tracking operations.

The servo control system 240 includes a DSP controller 242 and a drive IC 244. The DSP controller 242 adjusts pole and zero positions according to the control parameter Pc so as to control the drive IC 244 to change the control voltage Vc and thus to adjust the system characteristic parameters of the optical pickup head 210, such as the DC gain, bandwidth, phase margin, gain margin, or the like. Thus, the stability and efficiency of the focusing and tracking operations performed by the optical pickup head 210 may be enhanced.

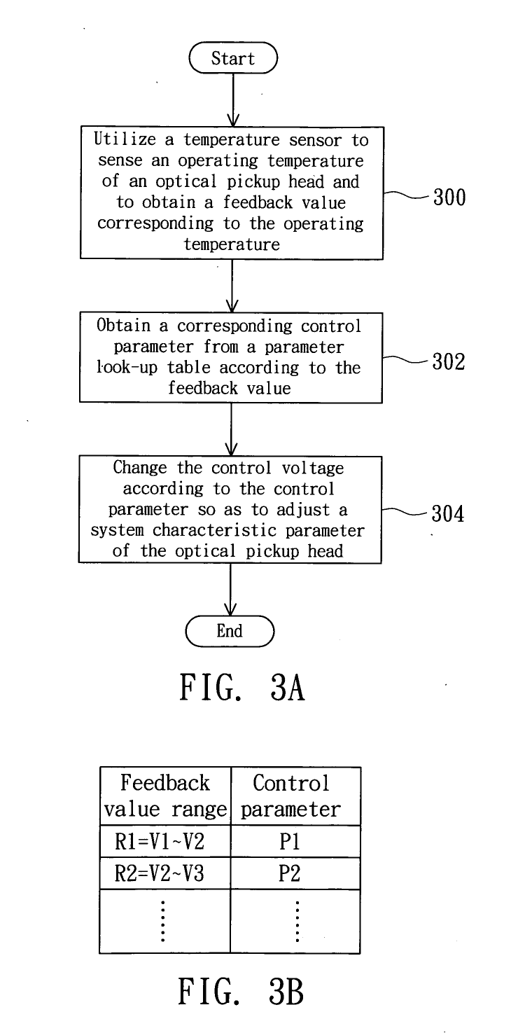

FIG. 3A is a flow chart showing a feedback control method according to a preferred embodiment of the invention. First, in step 300, the temperature sensor 220, such as the above-mentioned thermistor, is utilized to sense the operating temperature T of the optical pickup head 210 and to obtain the feedback value Sf (e.g., the voltage drop V between two ends of the thermistor) corresponding to the operating temperature T. Next, in step 302, the corresponding control parameter Pc is obtained from a parameter look-up table according to the feedback value Sf.

In this embodiment, the parameter look-up table, as shown in FIG. 3B, is previously set by firmware in the microcontroller 250. The parameter look-up table includes feedback value ranges Ri, such as feedback voltage ranges from V(i) to V(i+1) corresponding to operating temperature ranges from T(i) to T(i+1), and corresponding control parameters Pi that has to be outputted from the microcontroller 250. The system characteristic parameters, such as the DC gain and bandwidth, of the optical pickup head 210 are detected under different operating temperature ranges from T(i) to T(i+1), such as from 5° C. to 10° C., from 10° C. to 15° C., and the like, in a temperature control chamber. Then the control parameters Pi needed to be outputted from the microcontroller 250 are adjusted according to the detection result, such that the optical pickup head 210 operating under different operating temperatures can still have the same system characteristic parameters as operating at a room temperature.

During the optical reading/writing process, the temperature sensor 220 senses the operating temperature of the optical pickup head once a period of time, such as 20 ms. The microcontroller 250 outputs a corresponding control parameter Pc to control the servo control system 240 according to the feedback value range Ri corresponding to the feedback value Sf. Finally, in step 304, the control voltage Vc is changed according to the control parameter Pc in order to adjust the system characteristic parameters of the optical pickup head 210. The pole and zero positions of the DSP controller 242 are adjusted according to the control parameter Pc in order to change the control voltage Vc and thus adjust the system characteristic parameters of the optical pickup head 210. Consequently, the optical pickup head 210 can perform the focusing and tracking operations more precisely.

According to the above-mentioned preferred embodiment, the advantage of the feedback control system of the invention is that the microcontroller can adjust the output control parameter according to the feedback value of the temperature sensor so as to change the control voltage outputted from the servo control system and perform the temperature compensation for the system characteristic parameters of the optical pickup head. Therefore, the invention can prevent operating temperature change from influencing the stability and rate of the focusing and tracking operations performed by the optical pickup head, and thus enhance the data reading/writing quality of the optical pickup head.

While the invention has been described by way of examples and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A feedback control system, applied in an optical disk drive, the optical disk drive accessing data on an optical disk, the feedback control system comprising:
an optical pickup head, for emitting a laser beam onto the optical disk to read/write the data;
a temperature sensor, for sensing an operating temperature of the optical pickup head and outputting a feedback signal accordingly;
a microcontroller, for outputting a control parameter according to the feedback signal; and
a servo control system, for outputting a servo parameter to control the optical pickup head, wherein the servo control system changes the servo parameter to adjust a system characteristic parameter of the optical pickup head according to the control parameter.

2. The feedback control system according to claim 1, wherein the optical pickup head performs a focusing operation according to the servo parameter.

3. The feedback control system according to claim 1, wherein the optical pickup head performs a tracking operation according to the servo parameter.

4. The feedback control system according to claim 1, wherein the servo control system comprises a digital signal processing (DSP) controller and a drive IC, the DSP controller adjusts pole and zero positions according to the control parameter so as to control the drive IC to change the servo parameter and thus to adjust the system characteristic parameter of the optical pickup head.

5. The feedback control system according to claim 1, wherein the servo control system adjusts the servo parameter according to the control parameter such that the optical pickup head has the same system characteristic parameter as operating at a room temperature.

6. The feedback control system according to claim 1, wherein the servo parameter is a control voltage.

7. The feedback control system according to claim 1, wherein the system property parameter comprises a DC gain, a bandwidth, a gain margin and a phase margin.

8. The feedback control system according to claim 1, wherein the temperature sensor is a thermistor, and the feedback signal is obtained according to a voltage drop between two ends of the thermistor.

9. A feedback control method, applied in an optical disk drive, the optical disk drive comprising an optical pickup head and a servo control system, the optical pickup head for reading/writing data on an optical disk, the servo control system outputting a servo parameter to control the optical pickup head, the feedback control method comprising steps of:
sensing an operating temperature of the optical pickup head to obtain a feedback value corresponding to the operating temperature; and
changing the servo parameter according to the feedback value so as to adjust a system characteristic parameter of the optical pickup head.

10. The feedback control method according to claim 9, comprising setting a parameter look-up table comprising a plurality of feedback value ranges and control parameters corresponding to the feedback value ranges by firmware.

11. The feedback control method according to claim 10, wherein the step of adjusting the system characteristic parameter of the optical pickup head comprises:
obtaining the corresponding control parameter from the parameter look-up table according to the feedback value; and
changing the servo parameter according to the control parameter in order to adjust the system characteristic parameter.

12. The feedback control method according to claim 11, wherein the servo control system comprises a DSP controller, and the step of changing the servo parameter according to the control parameter comprises:
adjusting pole and zero positions of the DSP controller according to the control parameter and thus changing the servo parameter.

13. The feedback control method according to claim 9, wherein the feedback control method adjusts and holds the system characteristic parameter the same as the system property parameter of the optical pickup when operating at a room temperature.

14. The feedback control method according to claim 9, wherein the servo parameter is a control voltage.

15. The feedback control method according to claim 9, wherein the system characteristic parameter comprises a DC gain, a bandwidth, a gain margin and a phase margin.

16. The feedback control method according to claim 9, wherein the feedback control method utilizes a thermistor to sense the operating temperature and the feedback value is obtained according to a voltage drop between two ends of the thermistor.

17. The feedback control method according to claim 9, wherein the feedback control method senses the operating temperature once a fixed period of time.
